(19) United States
(12) Patent Application Publication
(10) Pub. No.: US 2005/0178014 A1
(43) Pub. Date: Aug. 18, 2005

(54) Drywall cutting guide

(76) Inventor: Daniel A. Tepei, Buford, GA (US)

Correspondence Address: DONALD R. SCHOONOVER, 4211 ROLLING HILLS DRIVE, NIXA, MO, 65714-8771, US

(21) Appl. No.: 10/777,856

(22) Filed: Feb. 13, 2004

(51) Int. Cl. B43L 13/02

(52) U.S. Cl. 33/42

(57) ABSTRACT

A T-shaped instrument includes a first body portion having an edge that is adapted to slide along an edge of a sheet of material and a second body portion that has a plurality of slots that are oriented to be parallel to the edge of the first body portion. An instrument, which can be a marking instrument or a cutting instrument, is placed in at least one of the slots and will mark or cut the sheet as the instrument is drawn along the edge of the sheet. Roller bearings can be located in the first body portion and markings, such as numbers, can be located on the second body portion adjacent to the slots.

### BACKGROUND OF THE INVENTION

1. Field of the Invention

The present invention relates to the general art of tools and geometric instruments, and to the particular field of cutting guides.

2. Discussion of the Related Art

Many buildings and static structures require some sort of inside wall forming materials. These materials often come in large sheets which are then fastened to building support elements. The sheets are often sold in standard sizes and these sheets are then cut on site to fit the particular building location.

There are several problems associated with this method of placing such sheets of material into place. One of the problems is accurately cutting the material. Still another problem is to cut the material in a manner that is parallel to the edge of the material so the edges of the finished product are all parallel with each other.

Therefore, there is a need for a tool that can be used to define cutting guide lines on a sheet of material.

One common form of material that is sold in large sheets is drywall. In many instances, a workman must cut many sheets of drywall for a single job. Substantial overall time-saving can be achieved if each sheet can be accurately cut in a minimum amount of time.

Therefore, there is a need for a tool that can be used to define cutting guide lines on a sheet of material such as drywall. Still further, there is a need for a tool that can be used to quickly and accurately define cutting guide lines on a sheet of material such as drywall.

Since, in some cases, these cutting guide lines must be parallel in order to make the sheet of material useful for its intended purpose, there is a need for a tool that can be used to quickly and accurately define parallel cutting guide lines on a sheet of material such as drywall.

### PRINCIPAL OBJECTS OF THE INVENTION

It is a main object of the present invention to provide a tool that can be used to define cutting guide lines on a sheet of material.

It is another object of the present invention to provide a tool that can be used to define cutting guide lines on a sheet of material such as drywall.

It is another object of the present invention to provide a tool that can be used to quickly and accurately define cutting guide lines on a sheet of material such as drywall.

It is another object of the present invention to provide a tool that can be used to quickly and accurately define parallel cutting guide lines on a sheet of material such as drywall.

### SUMMARY OF THE INVENTION

These, and other, objects are achieved by a drywall cutting guide that includes a T-shaped body having roller bearings in one portion of the body that are adapted to engage an edge of a sheet of material and a plurality of slots in another portion of the body that are adapted to accommodate a drywall cutting instrument. As the T-shaped body is moved along the edge of the material, a cutting instrument is placed in a selected one of the slots and will be drawn along the body of the material in a direction that is parallel to the edge of the material. It is noted that the edge being used to guide the instrument can be either a vertical edge or a horizontal edge or an oblique edge as suitable for the particular job. The instrument can cut completely through the material or simply scribe a line to be followed when a cut is made or to severe a covering layer of the material to facilitate breaking of the material, duch as drywall. In either case, the material can be cut to form an edge that is parallel to the edge being used to guide the cutting guide. The form of the instrument disclosed herein is used to cut drywall.

Using the drywall cutting guide embodying the present invention will permit a workman to define precisely located, consistent lines for cutting a sheet of material such as drywall. The lines will be parallel with each other and with the edge of the sheet of material and hence will be accurately and precisely placed. The time spent placing cutting guide lines will be reduced along with the increase in precision and accuracy.

### BRIEF DESCRIPTION OF THE DRAWING FIGURES

FIG. 1 is a perspective view of a drywall cutting guide embodying the present invention.

FIG. 2 is a view taken along line 2-2 of FIG. 1.

FIG. 3 is a detailed view of a portion of the drywall cutting guide shown in Figure, according to the present invention.

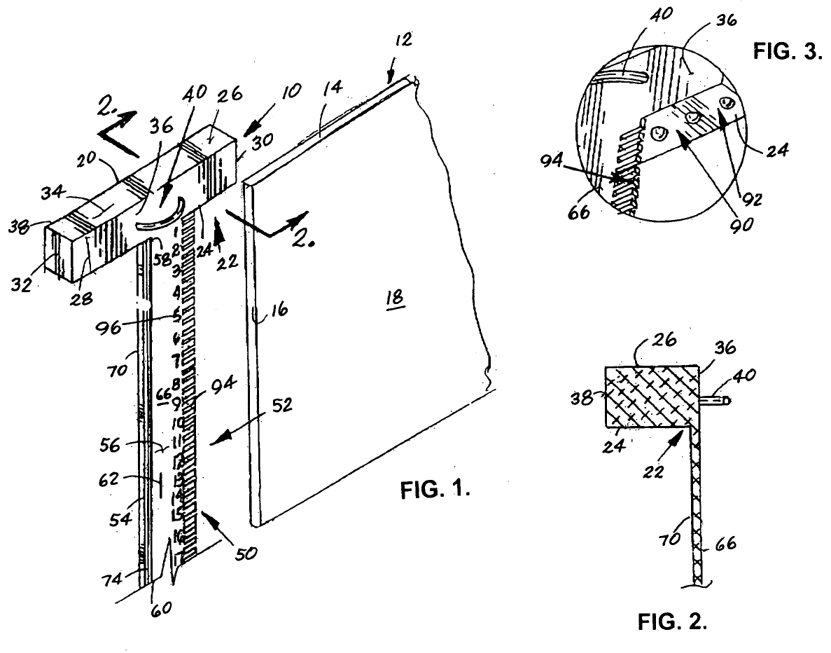

### DETAILED DESCRIPTION OF THE PREFERRED EMBODIMENT

Other objects, features and advantages of the invention will become apparent from a consideration of the following detailed description and the accompanying drawings.

Referring to the Figures, it can be understood that the present invention is embodied in a drywall cutting guide 10. Cutting guide 10 is used to cut and/or mark a piece of material, such as drywall 12, which includes a first edge 14, a second edge 16, and a planar face 18.

Drywall cutting guide 10 includes a T-shaped body 20 that is shaped in the nature of a T-square. Body 20 includes a first body portion 22 which has a first edge 24 which is adapted to be located adjacent to first edge 14 of sheet 12 being cut during use of the T-shaped body 20.

The first body portion 22 of drywall cutting guide 10 further includes a second edge 26, and a transverse axis 28 which extends between the first edge 24 of the first body portion 22 and the second edge 26 of the first body portion 22.

The first body portion 22 of drywall cutting guide 10 further includes a first end 30, a second end 32, and a longitudinal axis 34 which extends between the first end 30 of the first body portion 22 and the second end 32 of the first body portion 22.

The first body portion 22 of drywall cutting guide 10 further includes a first planar face 36, a second face 38, and a U-shaped handle 40 mounted on the first face 36 of the first body portion 22.

Drywall cutting guide 10 further includes a second body portion 50. Second body portion 50 includes a first edge 52 which is located adjacent to a planar surface of the drywall 12 during use of the T-shaped body 20. First edge 52 of the second body portion 50 is oriented to be perpendicular to first edge 24 of the first body portion 22.

Second body portion 50 further includes a second edge 54 and a transverse axis 56 which extends between the first edge 52 of the second body portion 50 and the second edge 54 of the second body portion 50.

Second body portion 50 further includes a first end 58, a second end 60, and a longitudinal axis 62 which extends between the first end 58 of the second body portion 50 and the second end 60 of the second body portion 50. Longitudinal axis 62 of the second body portion 50 is oriented to be perpendicular to longitudinal axis 34 of the first body portion 22.

Second body portion 50 further includes a first planar face 66 which is co-planar with first planar face 36 of the first body portion 22.

Second body portion 50 further includes a second face 70 which is planar and which slidably abuts a planar face of the sheet of material, such as planar face 18 of drywall 12, being cut during use of the T-shaped body 20.

Second body portion 50 further includes a groove 74 defined in the second edge 54 of the second body portion 50. Groove 74 extends from the first end 58 of the second body portion 50 to the second end 32 of the first body portion 22 and is used by the user to rest his or her thumb or finger on the cutting guide 10.

A plurality of roller bearings, such as roller bearings 90 and 92, are located in the first edge 24 of the first body portion 22. The roller bearings 90, 92 are spaced apart from each other in the direction of the longitudinal axis 34 of the first body portion 22 and rollably engage first edge 14 of the sheet of material being cut during use of the T-shaped body 20.

A plurality of slots, such as slot 94, are defined in the second body portion 50. The slots 94 extend parallel to the first edge 24 of the first body portion 22 and extend from the first edge 52 of the second body portion 50 toward the second edge 54 of the second body portion 50. The slots 94 are sized to be adapted to accommodate a drywall cutting and or marking instrument.

A plurality of indicia, such as number 96, are located on the first face 66 of the second body portion 50 adjacent to the slots 94.

Use of cutting guide 10 can be understood from the teaching of the foregoing disclosure and thus will not be described in detail. However, as can be understood, a sheet of material is marked or cut by placing guide 10 onto the sheet with edge 24 resting on edge 14 and slots 94 located adjacent to surface 18. A cutting instrument or a marking instrument is placed through at least one of the slots and into contact with surface 18. Guide 10 is then slid along edge 14 with the cutting or marking instrument in contact with surface 18 to define a cut or a mark. The defined cut or mark will be parallel to edge 14.

It is understood that while certain forms of the present invention have been illustrated and described herein, it is not to be limited to the specific forms or arrangements of parts described and shown.

1. A drywall cutting guide comprising:
a) a T-shaped body including
(1) a first body portion having
(A) a first edge which is adapted to be located adjacent to an edge of a sheet of material being cut during use of said T-shaped body,
(B) a second edge,
(C) a transverse axis extending between the first edge of the first body portion and the second edge of the first body portion,
(D) a first end,
(E) a second end,
(F) a longitudinal axis extending between the first end of the first body portion and the second end of the first body portion,
(G) a first planar face,
(H) a second face, and
(I) a U-shaped handle mounted on the first face of the first body portion, and
(2) a second body portion having
(A) a first edge which is adapted to be located adjacent to a planar surface of the sheet of material being cut during use of said T-shaped body, the first edge of the second body portion being perpendicular to the first edge of the first body portion,
(B) a second edge,
(C) a transverse axis extending between the first edge of the second body portion and the second edge of the second body portion,
(D) a first end,
(E) a second end,
(F) a longitudinal axis extending between the first end of the second body portion and the second end of the second body portion, the longitudinal axis of the second body portion being perpendicular to the longitudinal axis of the first body portion,
(G) a first planar face which is co-planar with the first planar face of the first body portion,
(H) a second face which is planar and which is adapted to slidably abut the planar surface of the sheet of material being cut during use of said T-shaped body, and
(I) a groove defined in the second edge of the second body portion to extend from the first end of the second body portion to the second end of the first body portion;
b) a plurality of roller bearings in the first edge of the first body portion, the roller bearings being spaced apart from each other in the direction of the longitudinal axis of the first body portion and being adapted to rollably engage the edge of the sheet of material being cut during use of said T-shaped body;
c) a plurality of slots defined in the second body portion, said slots extending parallel to the first edge of the first body portion and extending from the first edge of the second body portion toward the second edge of the second body portion, the slots being adapted to accommodate a drywall cutting or marking instrument; and
d) a plurality of indicia on the first face of the second body portion adjacent to the slots.

2. In combination:
a) a sheet of drywall having a first edge, a second edge, and a planar face; and
b) a drywall cutting guide comprising
(1) a T-shaped body including
(A) a first body portion having
(i) a first edge which is located adjacent to the first edge of the drywall,
(ii) a second edge,
(iii) a transverse axis extending between the first edge of the first body portion and the second edge of the first body portion,
(iv) a first end,
(v) a second end,
(vi) a longitudinal axis extending between the first end of the first body portion and the second end of the first body portion,
(vii) a first planar face,
(viii) a second face, and
(ix) a U-shaped handle mounted on the first face of the first body portion, and
(B) a second body portion having
(i) a first edge which is adapted to be located adjacent to a planar surface of said drywall, the first edge of the second body portion being perpendicular to the first edge of the first body portion,
(ii) a second edge,
(iii) a transverse axis extending between the first edge of the second body portion and the second edge of the second body portion,
(iv) a first end,
(v) a second end,
(vi) a longitudinal axis extending between the first end of the second body portion and the second end of the second body portion, the longitudinal axis of the second body portion being perpendicular to the longitudinal axis of the first body portion,
(vii) a first planar face which is co-planar with the first planar face of the first body portion,
(viii) a second face which is planar and which slidably abuts the planar surface of said drywall, and
(ix) a groove defined in the second edge of the second body portion to extend from the first end of the second body portion to the second end of the first body portion,
(2) a plurality of roller bearings in the first edge of the first body portion, the roller bearings being spaced apart from each other in the direction of the longitudinal axis of the first body portion and which rollably engage the edge of said drywall,
(3) a plurality of slots defined in the second body portion, said slots extending parallel to the first edge of the first body portion and extending from the first edge of the second body portion toward the second edge of the second body portion, the slots being adapted to accommodate a drywall cutting or marking instrument, and
(4) a plurality of indicia on the first face of the second body portion adjacent to the slots.

3. A drywall cutting guide comprising:
a) a T-shaped body having a first body portion having a face and a first edge and a second body portion having a second edge, with the second body portion being perpendicular to the first body portion;
b) roller bearings in the first edge of the first body portion, the roller bearings being adapted to engage an edge of a sheet of material;
c) a plurality of slots defined in the second edge of the second body portion, said slots extending parallel to the first edge of the first body portion and extending from the second edge of the second body portion, the slots being adapted to accommodate a drywall cutting or marking instrument; and
d) a U-shaped handle mounted on the face of the first body portion,
